(19) United States
(12) Patent Application Publication
(10) Pub. No.: US 2022/0081054 A1
(43) Pub. Date: Mar. 17, 2022

(54) MOTORCYCLE RADIATOR PROTECTOR DEVICE

(71) Applicants: Federico Gonzalez, JR., Emmaus, PA (US); Milagros Gonzalez, Emmaus, PA (US)

(72) Inventors: Federico Gonzalez, JR., Emmaus, PA (US); Milagros Gonzalez, Emmaus, PA (US)

(21) Appl. No.: 17/472,810

(22) Filed: Sep. 13, 2021

Related U.S. Application Data
(60) Provisional application No. 63/078,928, filed on Sep. 16, 2020.

(51) Int. Cl. B62J 23/00; B62J 41/00

(52) U.S. Cl. CPC B62J 23/00; F28F 2265/02; B62J 41/00

(57) ABSTRACT

The present invention relates to a motorcycle radiator protector device. The protector device is a two-layered device, having a front metal plate and a rear mesh plate. The front metal plate is visually exposed to users and the rear mesh plate is positioned in contact with the radiator. The metal front plate and the rear mesh plate work in conjunction to prevent debris from entering the radiator and causing damage. The front metal plate comprises a laser-cut design, allowing air to pass through the radiator and comprises a customized name for providing personalization. The front metal plate can be secured to the rear mesh plate through push buttons or screws with tabs, and the rear mesh plate is secured directly to the radiator through a plurality of bumper buttons.

### CROSS-REFERENCE TO RELATED APPLICATION

The present application claims priority to, and the benefit of, U.S. Provisional Application No. 63/078,928, which was filed on Sep. 16, 2020 and is incorporated herein by reference in its entirety.

### FIELD OF THE INVENTION

The present invention relates generally to the field of motorcycles. More specifically, the present invention relates to a radiator protector device comprising a front metal plate, a rear mesh plate and a plurality of fastening elements for attaching the front metal plate and the rear mesh plate together. The radiator protector device is a grille attachment that can be easily installed on a motorcycle grille, for protecting the radiator from being damaged due to debris entering the radiator. The radiator protector device features several bumper buttons that can be used to secure or release the protector device as needed. The radiator protector device of the present invention extends the life of a motorcycle and reduces the amount of money spent on repairs. Accordingly, the present disclosure makes specific reference thereto. Nonetheless, it is to be appreciated that aspects of the present invention are also equally applicable to other like applications, devices and methods of manufacture.

### BACKGROUND

Typically, conventional motorcycles comprise radiators that are fin-like structures, which ensure close contact with the hot coolant coming out of the vehicle's engine along with the outside air, thereby ensuring high rates of heat transfer from coolant to air. The radiators are generally not covered and are thus exposed to the outside environment. However, without a grille or a cover, rocks and other debris can easily enter the radiator and cause damage. Once the radiator is damaged, the heat transfer process is not efficiently performed, which causes the radiator to overheat. Further, along with the damaged and ineffective radiator, other parts of the vehicle that work in coordination with the radiator may also become damaged, which impacts the overall vehicle performance as well.

While vehicles such as motorcycles are in motion, debris can fly into the radiator and damage the radiator. The debris that enters the radiator structure cannot be removed or easily cleaned and may require experts to repair the vehicle radiator. Such expensive repairs may not be affordable by all users.

Additionally, with conventional radiators in motorcycles, there is always a risk of dirt and dust deposits in the crevices of the radiator structure, which creates a buildup of minerals in the small crevices of the radiator. This eventually damages the radiator and requires expensive repairs. The damaged radiator not only impacts the performance of the motorcycle but also reduces the life of the motorcycle.

Modern motorcycle radiators feature soft, lightweight aluminum cooling fins that respond very badly to rough handling and can easily be damaged. Further, if a user is riding the motorcycle in rough terrain, the radiator can easily be damaged as well. This causes an inconvenience to users travelling on long routes.

Therefore, there exists a long felt need in the art for a radiator protector device that protects the radiator of motorcycles and prevents the radiator from damage. There is also a long felt need in the art for a radiator protector device that prevents any debris or rocks from entering the radiator and causing damage to the radiator. Additionally, there is a long felt need in the art for a radiator protector device that prevents dirt and dust from depositing inside the crevices of the motorcycle radiator. Moreover, there is a long felt need in the art for a radiator protector device that protects the radiator from damage and eliminates the need for expensive repairs. Further, there is a long felt need in the art for a radiator protector device that protects the radiator from damage and extends the life of the vehicle as well. Furthermore, there is a long felt need in the art for a radiator protector device that is lightweight and affordable for users. Finally, there is a long felt need in the art for a radiator protector device that can be easily attached to the radiator of conventional motorcycles.

The subject matter disclosed and claimed herein, in one embodiment thereof, comprises an improved motorcycle radiator protector device. The radiator protector device comprises a metal front plate, a rear mesh plate, an LED strip, a plexiglass centerpiece, a pair of push buttons and a plurality of bumper buttons. More specifically, the metal front plate comprises laser cuts for allowing air to pass through to the radiator, and can even comprise a laser cut customized name for providing personalization of the radiator protector. Further, the metal front plate is attached to the rear mesh plate by the pair of push buttons, and the rear mesh plate is then attached to the radiator using said plurality of bumper buttons. The LED strip is detachably secured to the metal front plate circumscribing the laser cut customized name and illuminating the metal front plate. For reducing the glare of the LED light, a plexiglass centerpiece can be secured using mechanical fasteners.

In this manner, the novel radiator protector device of the present invention accomplishes all of the forgoing objectives, and provides a relatively safe, easy and convenient protector device which protects motorcycle radiators from debris, dust and stones. The device also increases the aesthetic appeal of the motorcycle and provides personalization. The device does not need an additional power source to provide power to the LED lights.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved motorcycle radiator protector device. The motorcycle radiator protector device is configured to prevent debris from entering the radiator and causing damage. The radiator protector device comprises a metal front plate, a rear mesh plate, an LED strip, a plexiglass centerpiece, a pair of push buttons and a plurality of bumper buttons. Specifically, the rear mesh plate is installed on the radiator and the metal front plate is visually exposed from outside. Further, the metal front plate comprises laser cuts, which allow air to pass through the radiator and comprises a laser-cut customized name for providing personalization to the radiator protector device. The metal front plate is secured to the rear mesh plate by the pair of push buttons, and then the rear mesh plate is secured to the radiator using said plurality of bumper buttons. An LED strip is detachably-secured to the metal front plate, circumscribing the laser-cut customized name and illuminating the metal front plate. For reducing the glare of the LED light, a plexiglass centerpiece is secured to the metal front plate using mechanical fasteners.

Both the rear mesh plate and the metal front plate prevent debris and stones thrown up by other vehicles from entering the motorcycle radiator, which protects the motorcycle radiator from physical damage. Further, the push buttons allow the metal front plate to snap on or off of the rear mesh plate via a push from the front surface of the metal front plate.

In yet another embodiment, zip ties are used for securing a wire connecting the LED light strip to an internal power supply of the motorcycle.

In yet another embodiment of the present invention, a radiator protector device configured to cover a motorcycle radiator is disclosed. The protector device comprises a two-layered structure with a metal front plate/grill and a rear mesh plate, secured together to protect the radiator from debris and dust. The front metal plate features a personalized text or name illuminated using an LED strip; the LED strip is powered by an internal battery of the motorcycle, on which the protector device is installed. The front metal plate is attached to the rear mesh plate through push buttons or screw with tabs. The rear plate comprises a mesh and the front metal grill comprises laser cuts, which allow air to pass through to the radiator.

In yet another embodiment of the present invention, the metal front plate and a rear mesh plate work in conjunction to prevent debris from entering the radiator and causing damage. The protector device extends the life of a motorcycle and reduces the amount of money spent on repairs.

In yet another embodiment of the present invention, a method of protecting a motorcycle radiator from debris by utilizing a radiator protector device is described. The method includes attaching a rear mesh plate in front of the radiator using bumper buttons, or alternatively mechanical screws, then connecting an LED strip of a single color or multiple colors to the power supply of the motorcycle, which allows the LED strip to light up when the ignition of the motorcycle is started. Further, attaching the plexiglass centerpiece to the front plate, such that the plexiglass is positioned between the rear mesh plate and the front plate and finally, positioning the metal front plate comprising laser cuts in front of the radiator and securing it to the rear mesh plate via push buttons or tabs with screws. In yet another embodiment of the present invention, the method includes attaching the LED strip to the front plate, such that it circumscribes the customized name on the front plate.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view disclosing the components of one embodiment of the radiator protector device of the present invention in accordance with the disclosed architecture;

FIG. 2 illustrates a perspective view disclosing one embodiment of the radiator protector device of the present invention in an assembled form in accordance with the disclosed architecture;

FIG. 3 illustrates a perspective view of another embodiment of the metal front plate used in the radiator protector device of the present invention in accordance with the disclosed architecture;

FIG. 4 illustrates a close-up view of the attachment of the metal front plate and the rear mesh plate of the radiator protector device of the present invention in accordance with the disclosed architecture;

FIG. 5 illustrates a flow diagram showing the steps performed by a user to attach the radiator protector device in front of a motorcycle radiator in accordance with the disclosed architecture;

FIG. 6 illustrates a front perspective view of a generalized metal front plate used in the radiator protector device of the present invention in accordance with the disclosed architecture; and

FIG. 7 illustrates a flow diagram showing the steps of manufacturing a customized metal front plate for use with a radiator protector device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a radiator protector device that protects a motorcycle radiator and prevents the radiator from damage. There is also a long felt need in the art for a radiator protector device that prevents debris or rocks from entering the radiator and causing damage to the radiator. Additionally, there is a long felt need in the art for a radiator protector device that prevents dirt and dust from depositing inside the crevices of the motorcycle radiator. Moreover, there is a long felt need in the art for a radiator protector device that protects a radiator from damage, and therefore eliminates the need for costly repairs. Further, there is a long felt need in the art for a radiator protector device that protects a radiator from damage and extends the life of the vehicle. Furthermore, there is a long felt need in the art for a radiator protector device that is lightweight and affordable by users. Finally, there is a long felt need in the art for a radiator protector device that can be easily secured to the radiator of a motorcycle.

The present invention, in one exemplary embodiment, is a novel radiator protector device configured to cover a motorcycle radiator. The radiator protector device comprises a two-layered structure, with a metal front plate/grill and a rear mesh plate secured together to protect the radiator from debris and dust. The front metal grill features a personalized text or name illuminated using an LED strip; the LED strip is powered by an internal battery of the motorcycle, on which the radiator protector device is installed. The front metal grill is secured to the rear mesh plate through push buttons or screw with tabs. The mesh plate comprises mesh and the front metal grill comprises laser cuts for allowing air to pass through to the radiator.

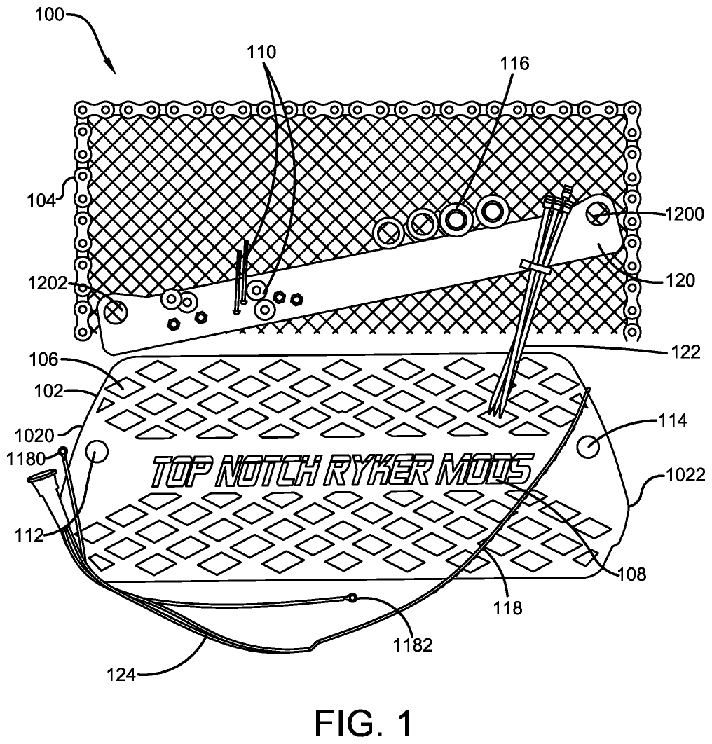

Referring initially to the drawings, FIG. 1 illustrates a perspective view disclosing the components of one embodiment of the radiator protector device of the present invention. The radiator protector device 100 of the present embodiment is a modified two-layered radiator grille attachment that protects a motorcycle radiator. The radiator protector device 100 protects the motorcycle radiator from physical damage and from dirt and debris. This extends the life of a motorcycle, and reduces the amount of money spent on radiator repairs. Specifically, the radiator protector device 100 comprises a metal front plate 102 and rear mesh plate 104. The rear mesh plate 104 is dimensioned as per the size and shape of a conventional motorcycle radiator grille. Thus, the rear mesh plate 104 is typically rectangular in shape, but can be any other suitable shape as is known in the art. The rear mesh plate 104 secures to the motorcycle radiator grill using mechanical fasteners, such as screws, at each corner of the rear mesh plate 104, or any other suitable fastener as is known in the art. The rear plate 104 is comprised of a mesh surface or structure, or any other suitable design or configuration which does not allow dirt or debris to enter the radiator. The rear mesh plate 104 is manufactured of a hard material such as stainless steel, or any other suitable material as is known in the art and is corrosion-resistant and weatherproof.

The metal front plate 102 is a designer plate that is visually exposed when the radiator protector device 100 is installed on a motorcycle. The metal front plate/grille 102 has a trapezium-like shape, but can be any suitable shape as is known in the art. Further, the metal front plate 102 comprises arcuate, non-parallel sides 1020, 1022 and a cutout design 106 along the surface of the plate/grille 102, such that air is able to flow through the metal front plate 102 and into the radiator. Further, the metal front plate 102 also comprises any indicia, logo, tagline or any other text 108 as is known in the art, preferably along the medial lateral axis of the metal plate 102, but can also be positioned at any other suitable position on the metal front plate 102. The text 108 is also cut out or carved into the metal plate 102 and can be customized as per the wants and/or needs of a user. The cutout design 106 and the text 108 are laser-cut and designed for maximum airflow to the radiator, such that cooling isn't compromised while using the radiator protector device 100. Further, the metal front plate 102 can also come in various colors such as black, red, white, brown, etc., or any other suitable color as is known in the art to match with the motorcycle. Additionally, it should be appreciated that the metal front plate 102 acts as a custom name grille that can be customized for different types of commercially available motorcycles.

The metal front plate 102 is configured to be securely-attached in front of the rear mesh plate 104, using a fastening means such that the customized tag line 108 and cutout design 106 are visually exposed to users. Specifically, the fastening means in one embodiment of the radiator protector device 100 comprises tabs with screws 110 that are applied to the fastening slots 112, 114 disposed on the metal front plate 102. The tabs with screw fasteners 110 are slotted through the fastening slots 112, 114 and fasten to the rear mesh plate 104, thereby allowing a secure attachment of the rear mesh plate 104 and the metal front plate 102. In other embodiments of the radiator protector device 100, the metal front plate 102 and the rear mesh plate 104 can be fastened using push buttons 116, or any other suitable fasteners as is known in the art. The advantage of push buttons 116 is that detaching the metal front plate 102 from the rear mesh plate 104 is easy, and only requires a user to press the push buttons 116 which releases the metal front plate 102. The details of push button usage are described later in the disclosure.

In order to add illumination to the metal front plate 102 and the customized text 108, an illumination source such as a LED strip 118 is provided, that is secured along the customized text 108 on the back surface of the metal front plate 102. The LED strip 118 can be connected to a built-in power source of the motorcycle using LED strip connectors 1180, 1182 and connector wire 124. The connectors 1180, 1182 and connector wire 124 connect the LED strip 118 with the battery of the motorcycle, and thus when the ignition of the motorcycle is turned on, the LED strip 118 is automatically activated. To secure the LED strip 118 and the connector wires 124 of the LED strip 118, zip ties 122 or any other suitable fasteners as are known in the art can be used to create the secure connection, and bring aesthetic appeal to the motorcycle. Further, the LED strip 118 provides an aesthetic appeal to the motorcycle, while also providing additional protection to the radiator. The lights of the LED strip 118 can come in multiple colors such as yellow, red, blue, green or any combination of multiple colors.

Further, to reduce the glaring effect of the LED strip 118, a plexiglass component 120 can be fastened to the metal front plate 104, using screws or any other suitable fastening means as are known in the art. The plexiglass component 120 is typically positioned in the center of the front plate 101 and can be secured to either the front or back of the metal front plate 102. To secure the plexiglass 120, plexiglass holes 1200, 1202 are aligned with fastening slots 112, 114, respectively, and then fastened using the tabs with screws 110, or any other suitable fastening means as are known in the art.

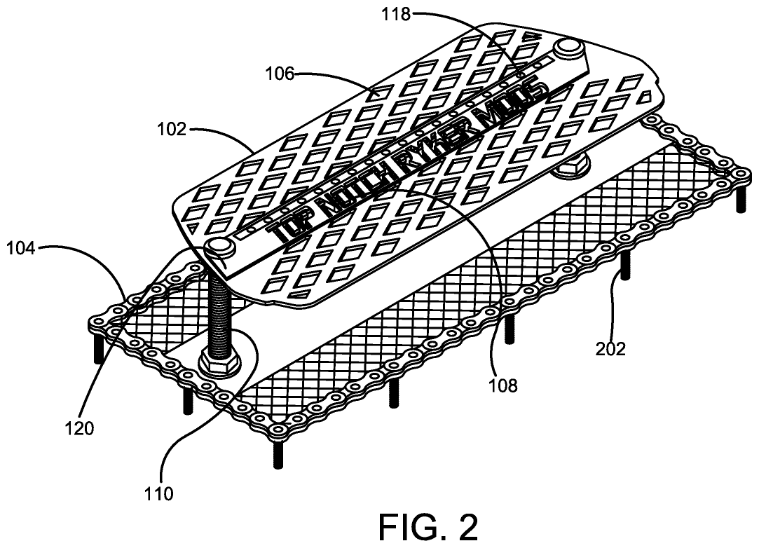

FIG. 2 illustrates a perspective view showing one embodiment of the radiator protector device of the present invention in an assembled form. When the radiator protector device 100 is assembled, the metal front plate 102 is secured to the rear mesh plate 104 using screws 110. The cutout design 106 of the metal front plate 102 can be of any suitable shape and size as is known in the art, as long as air can flow freely through the cutout design 106. Further, the customized text 108 is surrounded by the LED strip 118, which is disposed on the rear or back side of the front metal plate 102. Then, the rear mesh plate 104 is secured to the motorcycle radiator using the screws/bumper buttons 202, or any other suitable fastener as is known in the art. In one embodiment, instead of using the screws 202, bumper buttons can be used to attach the rear mesh plate 104 to the radiator grille. The front plate 102 and the rear mesh plate 104 are then secured together, and both the rear mesh plate 104 and the metal front plate 102 protect the motorcycle radiator from physical damage, while also enhancing the aesthetic look of the motorcycle. Further, a plexiglass component 120 can be secured to the front plate 102 as well. The plexiglass component 120 can be used both as an additional protective cover, and to reduce the glaring effect of the LED strip 118. Additionally, it should be noted that the metal front plate 102 can be easily removed from the rear mesh plate 104 via tabs and screws, or alternatively through the push buttons, or any other suitable fasteners as are known in the art.

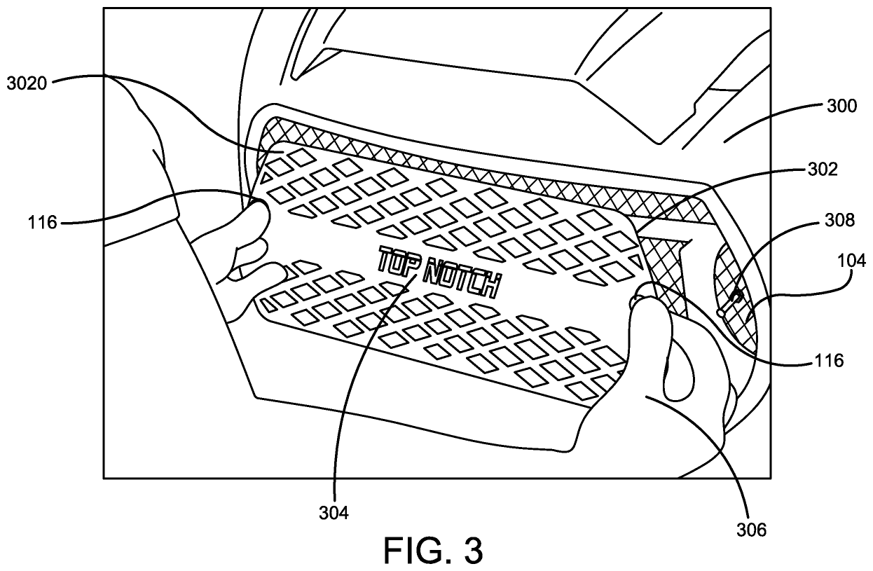

FIG. 3 illustrates a perspective view of another embodiment of the metal front plate used in the radiator protector device of the present invention. In the present embodiment, the metal front plate 302 comprises designer cutouts 3020 for air to pass through. The cutout designs 3020 in the front metal plate 302 are laser-cut for a smooth finish. Further, customized text 304 can be added to the metal front plate 302. The customized text 304 would also be laser-cut for maximum airflow to the radiator such that cooling isn't compromised while using the radiator protector device. Further, the customized text 304 is illuminated using an LED strip as described supra. The metal front plate 302 is secured to the radiator 300 and to the rear mesh plate 104 using push buttons 116. Specifically, a pair of push buttons 116 are used, and the push buttons 116 can be pressed by a user 306 to release the front metal plate 302 from the screws 308. To attach the metal plate 302, the push buttons 116 are pushed to snap back the metal plate 302 onto the screws 308 of the rear mesh plate 104, thus securing the front metal plate 302 to the radiator 300.

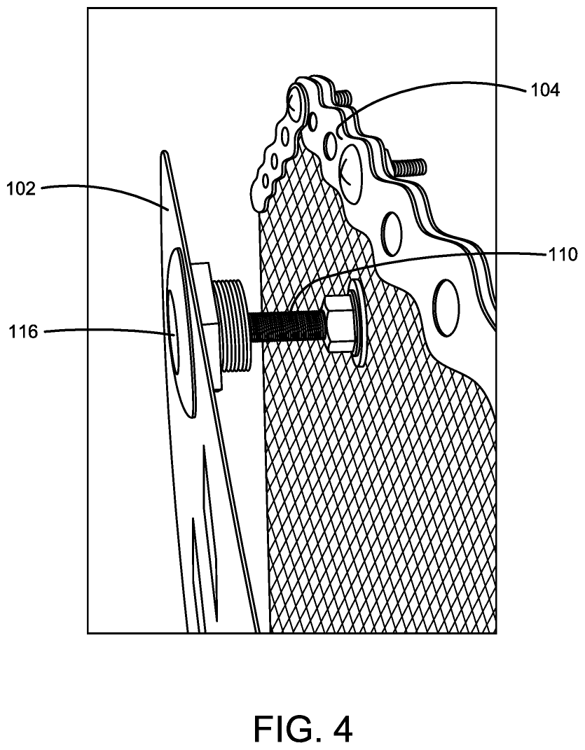

FIG. 4 illustrates a close-up view of the attachment of the metal front plate and the rear mesh plate of the radiator protector device of the present invention. An advantage of the present invention is that the metal front plate 102 and the rear mesh plate 104 can be secured to each other using the push buttons or tabs with screws. Both the variants of the fastening means are available separately, and can be used with equal effectiveness. In the present embodiment, the metal front plate 102 uses a push button 116 that can push the screw 110 to snap off, and snap on the front plate 102 to the rear mesh plate 104. In this embodiment, the rear mesh plate 104 is permanently secured to the screws 110, and only the front metal plate 102 can be removed easily.

It should be appreciated that both the front plate 102 and the rear mesh plate 104 are of the same dimensions as the front area of a motorcycle radiator. The device 100 protects the motorcycle radiator from debris and stones that can be thrown up by other vehicles. The metal front plate 102 can be manufactured of stainless steel or aluminum, or any other suitable metal as is known in the art, and is power-coated and impervious to rust. Preferably, the metal front plate 102 is manufactured of a 5 mm steel sheet. The radiator protector device can be custom designed for radiators of any commercially available motorcycle. The metal front plate 102 can be customized as per the needs and/or wants of a user, with the custom text and also with the choice of LED color.

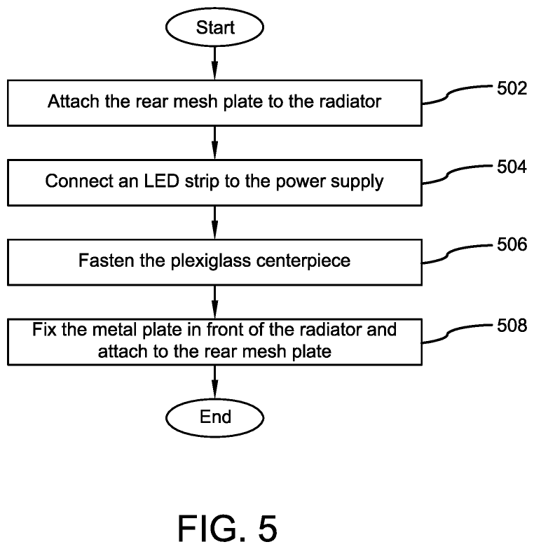

FIG. 5 illustrates a flow diagram showing the steps performed by a user to attach the radiator protector device on a radiator of a motorcycle. Initially, at 502, a rear mesh plate is chosen and attached in front of a radiator. The rear mesh plate can be attached using bumper buttons, or alternatively through mechanical screws. Then at 504, an LED strip of a single color or multiple colors is connected to the power supply of the motorcycle, thereby allowing the LED strip to light up when the ignition of the motorcycle is started. Thereafter, at 506, the plexiglass component is secured to the front metal plate such that the plexiglass component is positioned between the rear mesh plate and the front metal plate. Finally, at 508, the metal front plate comprises laser cuts and is positioned in front of the radiator, and is attached to the rear mesh plate through push buttons or tabs with screws.

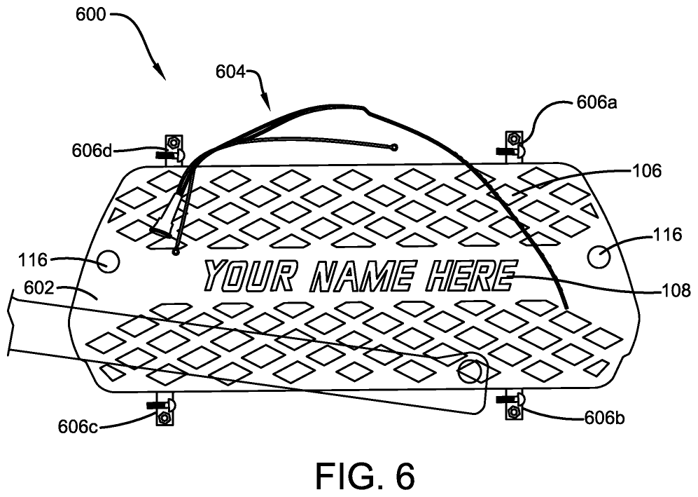

FIG. 6 illustrates a front perspective view of a generalized metal front plate used in the radiator protector device of the present invention. As shown, the metal front plate 600 can comprise push buttons 116 or the four attachments 606a, 606b, 606c, 606d for screws with tab attachments. The push buttons 116 and the four screws with tab attachments are used for securing the metal front plate 600 to the rear mesh plate. The cut designs 106 can be laser-cut, and the customized name 108 is also laser-cut. The front side 602 is visually exposed to users and the rear surface 604 faces the radiator of the motorcycle. Typically, either the push buttons or the screws with tabs are used in securing the metal front plate to the motorcycle radiator.

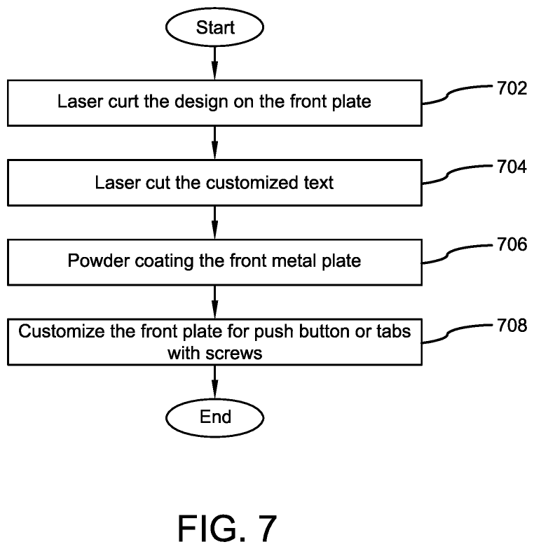

FIG. 7 illustrates a flow diagram showing the steps of manufacturing a customized metal front plate for a user. As stated earlier, the metal front plate is hard, durable and sturdy, and can be customized as per a user's needs and/or wants. When manufacturing the metal front plate used in the radiator protector device of the present invention, initially, at 702, the cutout design is laser-cut into the metal front plate. Laser cuts are also necessary for providing adequate air circulation to the radiator to avoid overheating of the radiator. Then at 704, based on the preferences of users, a customized name or tag is laser-cut along the central lateral line of the front metal plate. Then at 706, the metal front plate is powder-coated to increase its strength. Powder coating is a type of coating in a form of a powder that is electrostatically applied onto the metal then cured at a high heat temperature. This process creates a hard finish that is tougher than conventional paint and long-lasting, and also very durable for both indoor and outdoor elements. Finally at 708, the powder-coated metal plate is customized and designed to accommodate a push button fit or a tab with screws fit, based on both the preferences of the users and/or design of the motorcycle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorcycle radiator protector device”, “radiator protector device”, “protector device”, and “improved radiator protector device” are interchangeable and refer to the motorcycle radiator protector device 100 of the present invention.

Notwithstanding the forgoing, motorcycle radiator protector device 100 of the present invention can be of any suitable size and configuration as is known in the art without affecting the overall concept of the invention, provided that it accomplishes the above-stated objectives. One of ordinary skill in the art will appreciate that the size, configuration and material of the motorcycle radiator protector device 100 as shown in FIGS. 1-7 is for illustrative purposes only, and that many other sizes and shapes of a motorcycle radiator protector device 100 are well within the scope of the present disclosure. Although the dimensions of the motorcycle radiator protector device 100 are important design parameters for user convenience, the motorcycle radiator protector device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A radiator protector device which protects a motorcycle radiator from physical damage and from dirt and debris, the radiator protector device comprising:
a rear plate secured to the motorcycle radiator; and
a metal front plate secured to the rear plate, wherein the metal front plate is visually exposed when the radiator protector device is installed on a motorcycle.

2. The radiator protector device of claim 1, wherein the rear plate is secured to the radiator via a screw at each corner of the rear plate.

3. The radiator protector device of claim 2, wherein the rear plate comprises a mesh structure to block the dirt and debris from entering the radiator.

4. The radiator protector device of claim 3, wherein the metal front plate comprises a cutout design along a surface of the metal front plate.

5. The radiator protector device of claim 4, wherein the cutout design is laser cut such that air is able to flow through the metal front plate and into the radiator.

6. The radiator protector device of claim 5, wherein the metal front plate comprises an indicia positioned along a medial lateral axis of the metal front plate.

7. The radiator protector device of claim 6, wherein the indicia is laser cut such that air is able to flow through the metal front plate and into the radiator.

8. The radiator protector device of claim 7, wherein the cutout design and the indicia are laser cut and designed for maximum airflow to the radiator.

9. The radiator protector device of claim 8, wherein the metal front plate is secured to the rear plate via tabs with screws which are applied to fastening slots disposed on the metal front plate.

10. The radiator protector device of claim 8, wherein the metal front plate is secured to the rear plate via push buttons.

11. The radiator protector device of claim 1 further comprising a LED strip to illuminate the metal front plate.

12. The radiator protector device of claim 11, wherein the LED strip is connected to a built-in power source of the motorcycle via LED strip connectors and a connector wire.

13. The radiator protector device of claim 12 further comprising a plexiglass component fastened to the metal front plate to reduce glare effect of the LED strip.

14. The radiator protector device of claim 13, wherein the plexiglass component is secured to the metal front plate via aligning plexiglass holes with fastening slots and then utilizing tabs with screws to fasten.

15. A radiator protector device which protects a motorcycle radiator from physical damage and from dirt and debris, the radiator protector device comprising:
a rear mesh plate secured to the motorcycle radiator;
a metal front plate secured to the rear mesh plate via tabs with screws which are applied to fastening slots disposed on the metal front plate; and
a LED strip to illuminate the metal front plate, wherein the metal front plate is visually exposed when the radiator protector device is installed on a motorcycle, and further wherein the metal front plate comprises a laser cutout design and laser cut indicia along a surface of the metal front plate for air flow.

16. The radiator protector device of claim 15, wherein the metal front plate is secured to the rear mesh plate via push buttons.

17. The radiator protector device of claim 15 further comprising a plexiglass component fastened to the metal front plate to reduce glare effect of the LED strip.

18. A method of securing a radiator protector device on a motorcycle radiator comprising the steps of:
securing a rear mesh plate in front of the motorcycle radiator;
connecting an LED strip of a single color or multiple colors to a power supply of a motorcycle allowing the LED strip to light up when ignition of the motorcycle is started;
securing a plexiglass component to a front metal plate such that the plexiglass component is positioned between the rear mesh plate and the front metal plate; and
positioning the front metal plate in front of the radiator and attaching the front metal plate to the rear mesh plate through push buttons or tabs with screws.

19. The method of claim 18, wherein the front metal plate comprises laser cut designs and a customized name for air flow.

20. The method of claim 18, wherein the front metal plate is powder coated to increase strength.
